(19) United States
(12) Patent Application Publication
(10) Pub. No.: US 2025/0037560 A1
(43) Pub. Date: Jan. 30, 2025

(54) FOREST FIRE EARLY DETECTION SYSTEM WITH PIEZO/BIMETALLIC SENSOR, AND METHOD FOR OPERATING A FOREST FIRE EARLY DETECTION SYSTEM

(71) Applicant: DRYAD NETWORKS GMBH, Eberswalde (DE)

(72) Inventors: Carsten BRINKSCHULTE, Berlin (DE); Marco BÖNIG, Dortmund (DE)

(73) Assignee: DRYAD NETWORKS GMBH, Eberswalde (DE)

(21) Appl. No.: 18/712,770

(22) PCT Filed: Nov. 25, 2022
(86) PCT No.: PCT/EP2022/083292

§ 371 Date: May 23, 2024

(30) Foreign Application Priority Data
Nov. 26, 2021 (DE) 10 2021 131 104.7

(51) Int. Cl. G08B 17/00; G08B 17/06; G08B 25/10; H01H 37/00; H01H 37/52

(52) U.S. Cl. CPC G08B 17/005; G08B 17/06; G08B 25/10; H01H 37/006; H01H 37/52

(57) ABSTRACT

The invention relates to a forest fire early detection system with a terminal, wherein the terminal has a sensor unit, wherein the sensor unit has a first and a second bimetallic signal transmitter, wherein the two bimetallic signal transmitters are designed differently from one another. The invention further relates to a method for detecting forest fires with the method steps of detecting the amount of heat energy from a first bimetallic signal transmitter of a forest fire early detection system, converting the amount of heat energy into a deformation of the bimetal of the first bimetallic signal transmitter, generating a first signal through the deformation of the bimetal of the first bimetallic signal transmitter.

The invention relates to a forest fire early detection system with a terminal, wherein the terminal has a sensor unit, wherein the sensor unit has a first and a second bimetallic signal transmitter, wherein the two bimetallic signal transmitters are designed differently from one another. The invention further relates to a method for detecting forest fires with the method steps of detecting the amount of heat energy from a first bimetallic signal transmitter of a forest fire early detection system, converting the amount of heat energy into a deformation of the bimetal of the first bimetallic signal transmitter, generating a first signal through the deformation of the bimetal of the first bimetallic signal transmitter.

### PRIOR ART

Systems for early detection of forest fires are known. For this purpose, the area to be monitored is monitored using sensors. These sensors are, for example, rotatable cameras, but they have the disadvantage that they are less effective at night. Monitoring from a high orbit using an IR camera installed in a satellite has the disadvantage that the satellite is not geostationary, so it requires a certain amount of time to complete one orbit during which the area is not monitored. A satellite is also expensive to purchase, maintain and especially when launching the satellite. Monitoring by mini-satellites in low orbit usually requires a number of satellites, which are also expensive to launch. Satellite monitoring also involves high carbon dioxide emissions during launch.

Furthermore, bimetal-piezo switches are known. The bimetals of these switches deform when temperature changes and thus trigger an electrical impulse through the deformation of a piezo crystal coupled to the bimetal.

It makes more sense to monitor the area using a number of inexpensive, mass-produced sensors. The sensors are distributed throughout the area and deliver data to a base station via radio connection.

Such a system for early detection of forest fires is presented in US 2008/0309502 A1. In the event of a fire alarm, a sensor delivers information to a nearby control terminal, which then triggers an alarm using a long-range radio frequency signal. This system has the disadvantage that the control terminal triggers the alarm and must have a powerful RF unit to do so. The sensors require a GPS unit that constantly sends a signal to the control terminal. Power consumption of the sensors is therefore high, and the service life of the sensors' energy sources (batteries) is limited.

Devices and sensors that are used, for example, to monitor systems and areas often only require a small amount of energy, either because they are not in constant operation or because the sensor technology itself is designed to save energy. For example, batteries—also rechargeable—are used to supply energy. However, it can still make sense to avoid batteries because testing and replacing them is too time-consuming if the consumers are installed in an inaccessible location or are difficult to reach. In particular, the sensor system should be sufficiently sensitive and robust as well as designed to be as energy-saving as possible. Due to the risk of spontaneous combustion, Li-ion batteries are also not suitable for this purpose.

It is therefore the object of the present invention to provide an improved forest fire early detection system that is energy-saving and reliable, can be expanded as required and is cost-effective to install and maintain.

It is also an object of the present invention to provide an improved method for forest fire early detection, with which a forest fire early detection system can be operated in an energy-saving and reliable manner.

The object is achieved using the forest fire early detection system according to claim 1. Advantageous embodiments of the invention are set out in the dependent claims 2-13.

The forest fire early detection system according to the invention has a terminal that has a sensor unit. According to the invention, the sensor unit has a first bimetallic signal transmitter. The bimetallic signal transmitter has a bimetallic strip with two layers of different metals on top of each other. The two layers are connected to one another in a cohesive or form-fitting material. Due to the different thermal expansion coefficients of the metals used, one of the layers expands more than the other, causing the bimetallic strip to deform when the temperature changes. This deformation is converted into a signal using the bimetallic signal transmitter.

In a further embodiment of the invention, part of the bimetallic strip is arranged to be freely movable, while another part of the bimetallic strip is mounted. Due to the different expansion coefficients of the two metals forming a bimetallic strip, the bimetallic strip deform both when heated and when cooled. When heated, the deformation changes, for example, from a substantially flat shape into a shape with a curvature.

In a further advantageous embodiment of the invention, the sensor unit has a second bimetallic signal transmitter. The first bimetallic signal transmitter is designed differently from the second bimetallic signal transmitter. Both bimetallic signal transmitters each have a bimetallic strip. The two bimetallic strips differ particularly in terms of their thermal expansion coefficients. As a result, the deformation of both bimetallic strip is different at a given temperature, which results in the generation of a signal at different temperatures.

In a further development of the invention, the first and/or the second bimetallic signal transmitter is coupled to a piezo element. The deformation of the bimetallic strip of the bimetallic signal transmitter generates an electrical voltage in the piezo element, which is detected and thus generates a signal in the first and/or second bimetallic signal transmitter.

In a further embodiment of the invention, the switching temperature of the first bimetallic strip is different from the switching temperature of the second bimetallic strip. In the context of this document, the switching temperature is the temperature at which the bimetallic strip is deformed in such a way that it generates a signal, for example by short-circuiting a circuit due to the deformation and/or generating an electrical voltage in a piezo element. The two bimetallic strips differ particularly in terms of their thermal expansion coefficients. As a result, the deformation of both bimetallic strip is different at a given temperature or the two bimetallic strip have the same deformation at different temperatures. This results in the two different bimetallic signal transmitters emitting a signal at different switching temperatures.

In a further embodiment of the invention, the sensor unit has an array of bimetallic signal transmitters. The array has a plurality of bimetallic signal transmitters. If the bimetallic signal transmitter is designed in the same way, the signal strength of the signal generated is increased compared to the use of a bimetallic signal transmitter, so the terminal therefore requires a less powerful and therefore more energy-saving power and communication unit.

In a further embodiment of the invention, the array has a plurality of different bimetallic signal transmitters. The bimetallic signal transmitters each have a bimetallic strip. The two bimetallic strips differ particularly in terms of their thermal expansion coefficients. As a result, the deformation of both bimetallic strip is different at a given temperature, which results in the generation of a signal at different temperatures. By means of an array comprising a plurality of different bimetallic signal transmitters, the temperature intervals between the individual signal temperatures can be precisely defined.

In a further embodiment of the invention, the plurality of different bimetallic signal transmitters of the sensor unit have different signal temperatures, with the respective bimetallic signal transmitter generating a signal when the signal temperature is reached. Both bimetallic signal transmitters each have a bimetallic strip. The respective bimetallic strips differ particularly in terms of their thermal expansion coefficients. As a result, the deformation of the differently designed bimetallic strips is different at a given temperature, which results in the generation of a signal at different signal temperatures. Depending on the signal temperature of the respective bimetallic signal transmitter, a plurality of signals are generated by each sensor unit.

In a further development of the invention, the sensor unit is coupled to a time detection. By means of time detection, the time, in particular the time at which a signal from a bimetallic signal transmitter is generated, can be detected.

In a further embodiment of the invention, the signal of the bimetallic signal transmitter detected by the sensor unit can be stored coupled with the respective time of detection of the signal. The captured signal is stored together with the time at which the signal was captured in a memory of the terminal and/or in a memory connected to the terminal. The forest fire early detection system according to the invention usually has a plurality of terminals that have one or more bimetallic signal transmitters. By knowing the times at which signals are generated by the bimetallic signal generator of the terminals, it is possible not only to determine the position of a forest fire, but also its speed of spread. In addition, the direction of spread of the forest fire can be determined if the number and location of the terminals detecting the forest fire as well as the times of the respective detection are known.

In a further embodiment of the invention, the forest fire early detection system comprises a mesh gateway network with a first gateway and a second gateway, wherein the first gateway communicates directly only with other gateways and terminals of the mesh gateway network, and the second gateway communicates with the network server.

In particular, the communication between terminals and a first gateway is direct, i. e., without further intermediate stations (single-hop connection). Communication between the gateways can take place via a direct single-hop connection; a multi-hop connection is also possible. This simultaneously extends the range of the mesh gateway network because the first gateway is connected to the second gateway via a mesh multi-hop network and can therefore forward the data from the terminals to the Internet network server. The connection between the second gateway network server is wireless or wired. The network also has multiple terminals. In such a network, one or more terminals are connected directly (single hub) to gateways via radio using LoRa modulation or FSK modulation FSK and communicate via the gateways with the Internet network server using a standard Internet protocol.

In further development of the invention, the mesh gateway network comprises an LPWAN and preferably a LoRaWAN. LPWAN describes a class of network protocols for connecting low-power devices such as battery-powered sensors to a network server. The protocol is designed in such a way that a long range and low energy consumption of the terminals can be achieved with low operating costs. LoRaWAN requires particularly little energy. The LoRaWAN networks implement a star-shaped architecture using gateway message packets between the terminals and the central network server. The gateways are connected to the network server, while the terminals communicate with the respective gateway via LoRa.

In an advantageous embodiment of the invention, the terminals and/or the first gateways have a self-sufficient energy supply. To be able to install and operate the terminals and the first gateways connected thereto even in inhospitable and especially rural areas far from energy supplies, the terminals and the first gateways are equipped with a self-sufficient energy supply. The energy supply can be provided, for example, by energy stores—also rechargeable ones. In particular, energy supply using solar cells should be mentioned, in which energy conversion from light to electrical energy takes place. The electrical energy is usually stored in an energy store to ensure energy supply even in times of low solar radiation (e. g. at night).

In a further development of the invention, the terminals and the first gateways can be operated off-grid. Due to the self-sufficient energy supply of terminals and first gateways, these devices can be operated autonomously without a supply network. Therefore, terminals and first gateways can be distributed and networked, particularly in impassable areas that cannot be reached with conventional radio networks.

The task is further achieved with the method according to the invention for detecting forest fires according to claim 14. Additional advantageous embodiments of the invention are set out in the dependent claims below.

The method for detecting forest fires according to the invention has three method steps: in the first method step, a first bimetallic signal transmitter of a forest fire early detection system detects an amount of thermal energy. In addition to heavy smoke, a forest fire produces a variety of gases, particularly carbon dioxide and carbon monoxide. The type and concentration of these gases are characteristic of a forest fire and can be detected and analyzed using suitable sensors. According to the invention, the temperature of the gases is detected. In addition to the type and concentration of the gases produced in a forest fire, their temperature is an indicator of a forest fire. In particular, the occurrence and/or presence of a forest fire is determined by means of the amount of heat energy absorbed by the first bimetallic signal transmitter. In the second method step, the amount of thermal energy is converted into a deformation of the bimetallic strip of the first bimetallic signal transmitter. In the third method step, a first signal is generated by the deformation of the bimetallic strip of the first bimetallic signal transmitter by short-circuiting a circuit due to the deformation of the bimetallic strip and/or generating an electrical voltage in a piezo element.

The bimetallic signal transmitter has a bimetallic strip with two layers of different metals on top of each other. The two layers are connected to one another in a cohesive or form-fitting material. Due to the different thermal expansion coefficients of the metals used, one of the layers expands more than the other, causing the bimetallic strip to deform when the temperature changes.

In a further embodiment of the invention, a second bimetallic signal transmitter of the forest fire early detection system absorbs a quantity of thermal energy. The amount of thermal energy is converted into a deformation of the bimetallic strip of the second bimetallic signal transmitter and a second signal is generated by the deformation of the bimetallic strip of the second bimetallic signal transmitter.

In a further development of the invention, the first bimetallic signal transmitter is different from the second bimetallic signal transmitter. Both bimetallic signal transmitters each have a bimetallic strip. The two bimetallic strips differ particularly in terms of their thermal expansion coefficients. As a result, the deformation of both bimetallic strip is different at a given temperature, which results in the generation of a signal at different temperatures.

In a further embodiment of the invention, the first bimetallic signal transmitter generates a signal at a signal temperature that is different from the signal temperature of the second bimetallic signal transmitter. The two bimetallic strips differ in particular in terms of their thermal expansion coefficients or the respective thickness of the individual metal layers. As a result, the deformation of both bimetallic strip is different at a given temperature, which results in the generation of a signal at different temperatures.

In a further embodiment of the invention, the signal generated by the first bimetallic signal transmitter triggers a message from the terminal containing the first bimetallic signal transmitter to a network server. The message contains in particular the signal temperature when the signal was generated. The message is sent wireless and/or by wire using a communication unit of the terminal to a network server which is connected to other network terminals, such as tablets, smartphones, PCs, using standard Internet protocols.

In a further embodiment of the invention, the time at which a signal generated by one of the bimetallic signal transmitters is generated is detected. By knowing the times at which signals are generated by the bimetallic signal generator of the terminals, it is possible not only to determine the position of a forest fire, but also its speed of spread. In addition, the direction of spread of the forest fire can be determined.

In a further development of the invention, the time between two signals detected by two different bimetallic signal transmitters is detected. The shorter the time between two signals detected by two different bimetallic signal transmitters, the higher the temperature increase in the vicinity of the bimetallic signal generator. A rapid rise in temperature when temperatures are not yet critical can also be an indication of a fire as a heat source. The increase in temperature gives the firefighting forces information about the direction and speed of spread of the forest fire.

In an advantageous embodiment of the invention, the detected time triggers a message from the terminal containing the bimetallic signal transmitter to a network server.

When using a LoRaWAN protocol to transmit the message from the terminal to a network server, different variants of terminals are implemented: Class A includes communication using the ALOHA access method. With this method, the device sends its generated data packets to the gateway, followed by two download receive windows that can be used to receive data. A new data transfer can only be initiated by the terminal during a new upload. Class B terminals, on the other hand, open download receive windows at specified times.

To do this, the terminal receives a time-controlled beacon signal from the gateway. This means that a network server knows when the terminal is ready to receive data. Class C terminals have a permanently open download receive window and are therefore permanently active, but also have increased power consumption.

In a further embodiment of the invention, the method is carried out by means of a forest fire early detection system, wherein the forest fire early detection system comprises a gateway network with a network server and multiple terminals, wherein the sensor unit is part of a terminal and the signals and/or the evaluated signals are transmitted to the network server via the gateway.

In a further development of the invention, the forest fire early detection system has a mesh gateway network with a first gateway and a second gateway, wherein the evaluated signals are transmitted to the network server via the first gateway and the second gateway. The first gateway communicates directly only with other gateways and terminals of the mesh gateway network, and the second gateway communicates with the network server.

In particular, the communication between terminals and a first gateway is direct, i. e., without further intermediate stations (single-hop connection). Communication between the gateways can take place via a direct single-hop connection; a multi-hop connection is also possible. This simultaneously extends the range of the mesh gateway network because the first gateway is connected to the second gateway via a mesh multi-hop network and can therefore forward the data from the terminals to the Internet network server. The connection between the second gateway network server is wireless or wired.

In another embodiment of the invention, the communication of the mesh gateway network takes place via an LPWAN and preferably a LoRaWAN protocol. LoRa uses particularly low energy and is based on chirp frequency spread modulation according to US patent U.S. Pat. No. 7,791,415 B2. Licenses for use are granted by Semtech. LoRa uses license- and permit-free radio frequencies in the range below 1 GHz, such as 433 MHz and 868 MHz in Europe or 915 MHz in Australia and North America, allowing a range of more than 10 kilometers in rural areas with the lowest energy consumption. The LoRa technology consists of the physical LoRa protocol and the LoRaWAN protocol, which is defined and managed as the upper network layer by the LoRa Alliance industrial consortium.

LoRaWAN networks implement a star-shaped architecture using gateway message packets between the terminals and the central network server. The gateways (also called concentrators or base stations) are connected to the network server via the standard Internet protocol, while the terminals communicate with the respective gateway by radio via LoRa (chirp frequency spread modulation) or FSK (frequency modulation). The radio connection is therefore a single-hop network in which the terminals communicate directly with one or more gateways, which then forward the data traffic to the Internet. Conversely, data traffic from the network server to a terminal is only routed via a single gateway. Data communication basically works in both directions, but data traffic from the terminal to the network server is the typical application and the predominant operating mode.

In an advantageous embodiment of the invention, the terminal and/or the first gateways are supplied with energy via a self-sufficient energy supply. To be able to install and operate the terminals and the first gateways connected thereto even in inhospitable and especially rural areas far from energy supplies, the terminals and the first gateways are equipped with a self-sufficient energy supply. The energy supply can be provided, for example, by energy stores—also rechargeable ones. In particular, energy supply using solar cells should be mentioned, in which energy conversion from light to electrical energy takes place. The electrical energy is usually stored in an energy store to ensure energy supply even in times of low solar radiation (e. g. at night).

In an advantageous embodiment of the invention, the terminals and the first gateways are operated off-grid. Due to the self-sufficient energy supply of terminals and first gateways, these devices can be operated autonomously without a supply network. Therefore, terminals and first gateways can be distributed and networked, particularly in impassable areas that cannot be reached with conventional radio networks.

Examples of embodiments of the forest fire early detection system according to the invention and of the method according to the invention for detecting forest fires are shown schematically in simplified form in the drawings and are explained in more detail in the following description.

In particular:

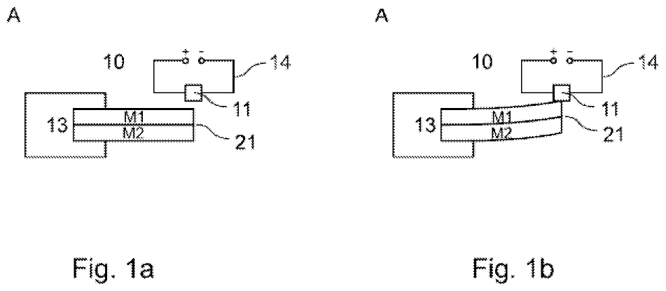

FIG. 1a shows a sensor unit according to the invention with a bimetallic signal transmitter and a piezo element, not actuated

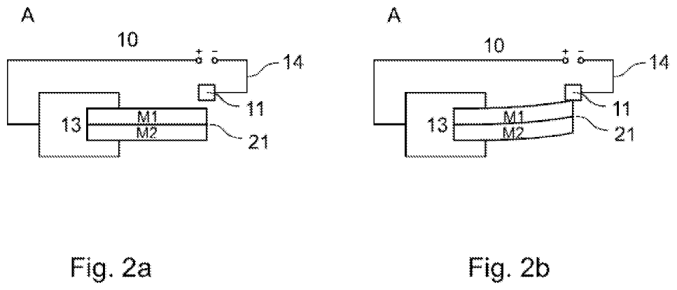

FIG. 1b shows a sensor unit according to the invention with a bimetallic signal transmitter and a piezo element, actuated FIG. 2a shows a sensor unit according to the invention with a bimetallic signal transmitter and a contact element, not actuated

FIG. 2b shows a sensor unit according to the invention with a bimetallic signal transmitter and a contact element, actuated

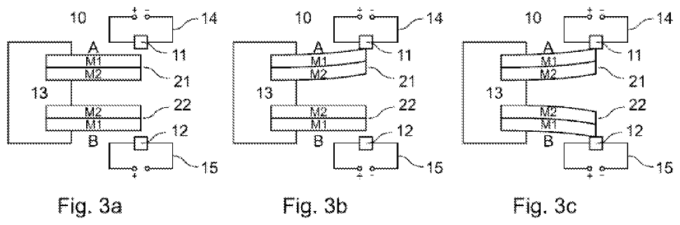

FIG. 3a shows a sensor unit according to the invention with two bimetallic signal transmitters and two piezo elements, not actuated

FIG. 3b shows a sensor unit according to the invention with two bimetallic signal generators and two piezo elements, first bimetallic signal transmitter actuated

FIG. 3c shows a sensor unit according to the invention with two bimetallic signal transmitters and two piezo elements, both bimetallic signal transmitters actuated

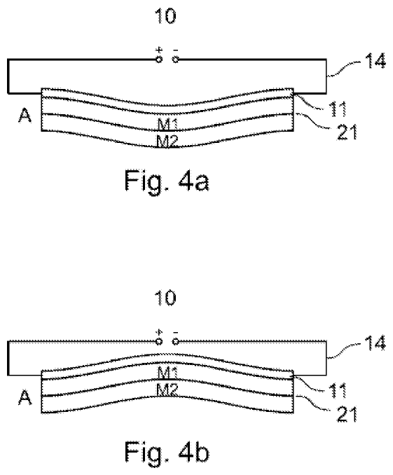

FIG. 4a shows a sectional view of a further bimetallic signal transmitter according to the invention, deflected into the first locking position

FIG. 4b shows a sectional view of a further bimetallic signal transmitter according to the invention, deflected into the second locking position

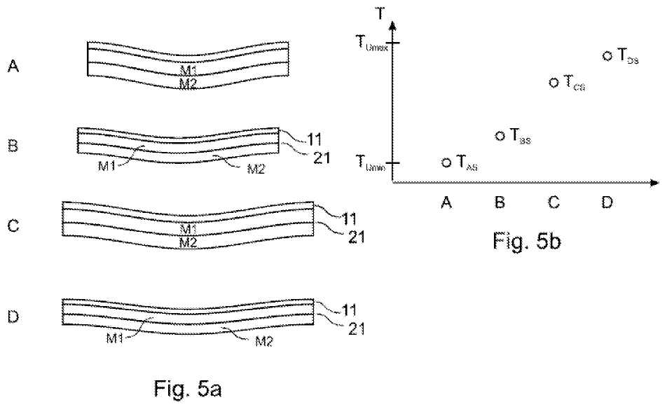

FIG. 5a shows a sectional view of an array of four bimetallic signal transmitters according to the invention

FIG. 5b shows a representation of the temperature intervals of the array of four bimetallic signal transmitters according to the invention

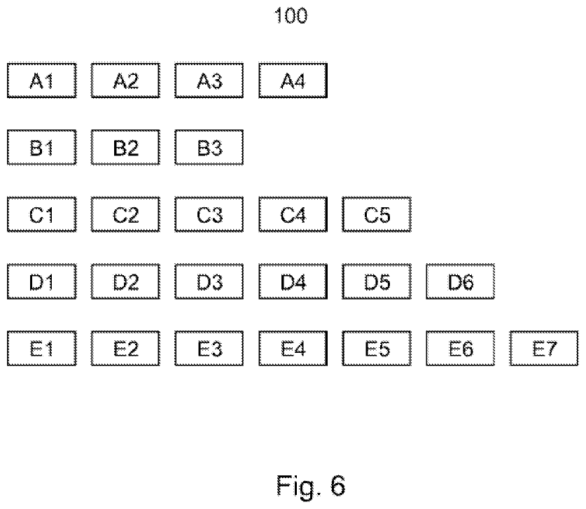

FIG. 6 shows an application of an array of bimetallic signal transmitters according to the invention

FIG. 1 shows an exemplary embodiment of a sensor unit 10 according to the invention with a bimetallic signal transmitter A and a piezo element 11. The sensor unit 10 has a first bimetallic signal transmitter A. The bimetallic signal transmitter A is formed from two layers M1, M2 made of different metals or alloys with different coefficients of thermal expansion, wherein the two layers M1, M2 are formed by rolling, welding, gluing or directly by application, e.g., can be connected to one another by directly spraying a second material onto a first material in such a way that a monolithic bimetallic strip 21.

The bimetallic signal transmitter A is mounted at one end in the bearing 13 in such a way that the end opposite the mounted end is freely movable in a direction perpendicular to the interfaces between the metallic layers M1, M2 (FIG. 1 a). The piezo element 11 is arranged near the movable end of the bimetallic strip 21 in such a way that when the bimetallic strip 21 is deflected, the piezo element 11 is deformed (FIG. 1 b). This deformation is converted by the piezo element 11 into an electrical voltage in the first electrical circuit 14.

In addition to the type and concentration of the gases produced in a forest fire, their temperature is an indicator of a forest fire. To detect forest fires, the first bimetallic signal transmitter A absorbs heat energy. The thermal energy is converted into a deformation of the first bimetallic signal transmitter A. The deformation is converted into an electrical voltage by the piezo element 11. When the first bimetallic strip A comes into contact with and exerts pressure on the first piezo element 11, electrical energy is generated in the first piezo element 11. The electrical voltage generated by the first circuit 14 is converted into a first signal. In addition, the time, in particular the point in time, at which the first signal was generated is detected. For this purpose, the sensor unit 10 has a timer which is connected to the bimetallic signal transmitter A. The first signal together with the time of its generation are stored in the terminal in which the bimetallic signal transmitter A is arranged and transmitted to a network server using a mesh gateway network.

A variant of the sensor unit 10 according to the invention with a bimetallic signal transmitter A is shown in FIG. 2. In this exemplary embodiment, the sensor unit 10 also has a first bimetallic signal transmitter A. The bimetallic signal transmitter A is mounted at one end in the bearing 13 in such a way that the end opposite the mounted end is freely movable in a direction perpendicular to the interfaces between the metallic layers M1, M2 (FIG. 2 a).

In this exemplary embodiment, however, the bimetallic signal transmitter A has a first contact element 11. The first contact element 11 is electrically conductive and arranged in such a way that when the bimetallic strip 21 is deflected and comes into contact with the first contact element 11, the first electrical circuit 14 is closed (FIG. 2 b), whereby a first signal is also generated.

FIG. 3 shows an exemplary embodiment of a sensor unit 10 according to the invention with two bimetallic signal transmitters A, B. The sensor unit 10 has a first bimetallic signal transmitter A and a second bimetallic signal transmitter B. The bimetallic signal transmitters A, B are arranged parallel to one another in the undeflected state (FIG. 3a). Both bimetallic strips 21, 22 are mounted at one end in the bearing 13 in such a way that the end opposite the mounted end is freely movable in a direction perpendicular to the interfaces between the metallic layers M1, M2.

Two piezo elements 11, 12 are arranged near the movable ends of the bimetallic strips A, B in such a way that when the first bimetallic strip 21 is deflected and a force is exerted, the first piezo element 11 is deformed, and when the second bimetallic lamella 22 is deflected and a force is exerted, the second piezo element 12 is deformed.

The design and material of the bimetallic signal transmitters A, B is selected in this exemplary embodiment such that at a first temperature T1 (FIG. 3b) the first bimetallic strip 21 touches the first piezo element 11, exerts pressure on it and so an electrical voltage is generated in the first circuit 14. The electrical voltage generated generates a first signal from the bimetallic signal transmitter A.

At a second temperature T2 (FIG. 3c) that is different from the first temperature T1, the bimetallic strips 21, 22 are deformed in such a way that they touch the first piezo element 11 and the second piezo element 12, exert pressure thereon and also generate an electrical voltage, which is generated both in the first circuit 14 and in the second circuit 15. The voltages generated by both piezo elements 11, 12 are different from the electrical voltage generated at the first temperature T1. The electrical voltages generated by both bimetallic strips 21, 22 generate a second signal that is different from the first signal.

FIG. 4 shows a sectional view of an exemplary embodiment of a sensor unit 10 according to the invention. The sensor unit 10 has the bimetallic signal transmitter A with two metallic layers M1, M2. The first metallic layer M1 is coated with a piezo element 11. There is therefore a permanent coupling between the bimetallic strip 21 and the piezo element 11. The piezo element 11 is connected to the first circuit 14.

In this exemplary embodiment, the bimetallic strip 21 is mounted at both ends in such a way that the bimetallic strip 21 can be moved between its ends in a direction perpendicular to the interfaces of the metallic layers M1, M2. Due to the different expansion coefficients of the two metallic layers M1, M2, the bimetallic strip 21 deforms both when heated and when cooled. In contrast to the previous exemplary embodiments (see. 1-3) this deformation does not occur continuously, but suddenly at a switching temperature of the bimetallic signal transmitter A.

The bimetallic strip 21 therefore has two different locking states depending on the temperature to which it is exposed. In both locking states, the bimetallic strip 21 has a different deformation. The deformation depends on the temperature to which it is exposed as well as on the original properties of the material, e.g., thickness, coefficient of thermal expansion. When the switching temperature transitions from the first rest state (FIG. 4a) to the second rest state (FIG. 4 b), a voltage in the first circuit 14 and a first signal are generated by means of the piezo element 11.

FIG. 5 shows an exemplary embodiment of an array 100 of four bimetallic signal transmitters A, B, C, D of the above exemplary embodiment (see. FIG. 4). A bimetallic signal transmitter A, B, C, D each has a bimetallic strip 21, each with two metallic layers M1, M2 (FIG. 5 a). Each first metallic layer M1 of a bimetallic strip 21 is coated with a piezo element 11. In one variant, both metallic layers M1, M2 of a bimetallic strip 21 are each coated with a piezo element 11, 12. The signal strength of a signal generated by the bimetallic signal transmitter A, B, C, D is thereby increased. All bimetallic strips 21 are mounted at their respective two ends in such a way that the bimetallic strip 21 are movable between their ends in a direction perpendicular to the interfaces of the metallic layers M1, M2.

The four bimetallic signal transmitters A, B, C, D each have different switching temperatures from one another (FIG. 5 b). The bimetallic signal transmitter A has the switching temperature TAS, the bimetallic signal transmitter B has the switching temperature TBS, the bimetallic signal transmitter C has the switching temperature TCS and the bimetallic signal transmitter D has the switching temperature TDS. In particular, the first bimetallic signal transmitter A has the lowest switching temperature of all four bimetallic signal transmitters A, B, C, D, and the fourth bimetallic signal transmitter D has the highest switching temperature. The temperature interval between the lowest switching temperature TAS and the highest switching temperature TDS defines the overall temperature interval in which the array 100 can be used.

The array 100 is advantageously arranged in a terminal that is part of a forest fire early detection system 1. To be able to install and operate the terminal in inhospitable and especially rural areas far away from energy supplies, the terminal is equipped with a self-sufficient energy supply.

When a forest fire occurs, the first bimetallic signal transmitter A with the lowest switching temperature TAS usually generates a first signal at time t1, whereby a message is generated on the terminal, which is sent to a network server via a mesh gateway network. The message also contains the time t1 of the generation of the first signal. If the ambient temperature increases due to a forest fire, the second bimetallic signal transmitter B with the next higher switching temperature TBS generates a second signal at a later time t2. A corresponding message with the time t2 of the generation of the second signal is sent to the network server. At a later time t3, the ambient temperature has reached the switching temperature TCS of the third bimetallic signal transmitter C, the terminal sends a third message to the network server at the time t3 when the signal is generated. Analogously, at a later time t4, at which the highest switching temperature TDS of the fourth bimetallic signal transmitter D is reached, the terminal sends a fourth message to the network server.

The forest fire early detection system 1 according to the invention usually has a plurality of terminals. In order to carry out the method according to the invention for detecting forest fires, the position of each individual terminal must be known as precisely as possible. The position can be determined, for example, when installing the terminal. The terminal can, for example, be arranged on a tree in the forest to be monitored and the position of the terminal can be determined once using a navigation satellite system, for example GPS (Global Positioning System). For example, a commercially available GPS system or a smartphone can be used.

The method for detecting a forest fire is not limited to the course described here. Depending on the ambient temperature, several or all of the bimetallic signal transmitters A, B, C, D arranged in the array 100 can also generate a signal at a time. A correspondingly generated message is then sent to the network server via the mesh gateway network along with the time at which the signal was generated.

A plurality of terminals generate a different number of signals at different times, which are collected and stored on the network server. By knowing the times tn at which signals are generated by the terminals, it is possible not only to determine the position of a forest fire, but also its speed of spread. In addition, the direction of spread of the forest fire can be determined if the number and location of the terminals detecting the forest fire as well as the times of the respective detection are known. To detect a forest fire, a single terminal can also have sensors for gas analysis and for detecting the prevailing wind direction.

The forest fire early detection system 1 has a mesh gateway network that uses the technology of a LoRaWAN network. The LoRaWAN network has a star-shaped architecture in which message packets are exchanged between the terminals and a central Internet network server by means of gateways. The forest fire early detection system 1 has a plurality of terminals that are connected to first gateways via a single-hop connection. The signals from the terminals are sent as a data packet to one or more first gateways using a single-hop connection via LoRa (chirp frequency spread modulation) or frequency modulation. The standard LoRa radio network has the typical star topology, in which one or more terminals EDn are connected directly (single hub) via radio to gateways using LoRa modulation or FSK modulation, while the gateways communicate with the Internet network server using a standard Internet protocol IP.

FIG. 6 shows an exemplary embodiment of a schematic arrangement of an array 100 in a terminal that is arranged in a forest fire early detection system 1. In this exemplary embodiment, the forest fire early detection system 1 has an array 100 of bimetallic signal transmitters A, A1, A2, A3, A4, B, B1, B2, B3, C, C1, C2, C3, C4, C5, D, D1, D2, D3, D4, D5, D6, E1, E2, E3, E4, E5, E6, E7.

The bimetallic signal transmitters A, A1, A2, A3, A4, wherein the bimetallic signal transmitters A, A1, A2, A3, A4 have the same switching temperature among themselves. In the same way, the bimetallic signal transmitters B, B1, B2, B3 have the same switching temperatures among themselves, the bimetallic signal transmitters C, C1, C2, C3, C4, C5 have the same switching temperatures among themselves, the bimetallic signal transmitters D, D1, D2, D3, D4, D5, D6 have the same switching temperatures, and finally the bimetallic signal transmitters E1, E2, E3, E4, E5, E6, E7 have the same switching temperatures.

However, the switching temperatures of the bimetallic signal transmitters A, B, C, D, E1 differ from each other: in this exemplary embodiment, the bimetallic signal transmitters A, A1, A2, A3, A4 have the lowest switching temperature, the bimetallic signal transmitters B, B1, B2, B3 have the next higher switching temperature, the bimetallic signal transmitters C, C1, C2, C3, C4, C5 have a higher switching temperature than the bimetallic signal transmitters B, B1, B2, B3, the bimetallic signal transmitters D, D1, D2, D3, D4, D5, D6 have a higher switching temperature than the bimetallic signal heads C, C1, C2, C3, C4, C5, the bimetallic signal heads E1, E2, E3, E4, E5, E6, E7 have the highest switching temperature.

The outbreak of a forest fire is usually accompanied by a steady increase in ambient temperature. When a forest fire occurs, the bimetallic signal transmitters A, A1, A2, A3, A4 with the lowest switching temperature each generate a first signal at time t1, whereby a message is generated on the terminal, which is sent to a network server via a mesh gateway network. The message also contains the time t1 of the generation of the first signals. If the ambient temperature increases due to a forest fire, the bimetallic signal transmitters B, B1, B2, B3 with the next higher switching temperature generate a second signal at a later time t2. A corresponding message with the time t2 of the generation of the second signal is sent to the network server. At a later time t3, the ambient temperature has reached the switching temperature of the bimetallic signal transmitters C, C1, C2, C3, C4, C5, each of which generates a third signal. The terminal sends a third message to the network server at the time t3 when the signals are generated. Analogously, at a later time t4, at which the next higher switching temperature of the bimetallic signal transmitters D, D1, D2, D3, D4, D5, D6 is reached, the terminal sends a fourth message to the network server. When the highest switching temperature is reached, the bimetallic signal transmitters E1, E2, E3, E4, E5, E6, E7 each generate a fifth signal at time t5, which generates a message on the terminal that is sent to you via the mesh gateway network.

The array 100 therefore generates different signals at different ambient temperatures, which are received by the network server together with their time stamp and are stored both on the terminal and on the network server.

Due to the knowledge of the times tn of the generation of the signals from the terminals, it is possible to determine the position of a forest fire, but also its propagation speed, by taking into account the time intervals in which the individual signals are generated. A short time interval between times t1 and t5 suggests a higher propagation speed, while a comparatively long time interval between times t1 and t5 suggests a low propagation speed.

LIST OF REFERENCE NUMERALS

| | |
|---|---|
| 1 | forest fire early detection system |
| 10 | sensor unit |
| 11 | first contact element/first piezo element |
| 12 | second contact element/second piezo element |
| 13 | bearing |
| 14 | first circuit |
| 15 | second circuit |
| 21, 22, 23, 24 | bimetallic strip |
| 100 | array |
| A, A1, A2, A3, A4 | first bimetallic signal transmitter |
| B, B1, B2, B3 | second bimetallic signal transmitter |
| C, C1, C2, C3, C4, C5 | third bimetallic signal transmitter |
| D, D1, D2, D3, D4, D5, D6 | fourth bimetallic signal transmitter |
| E1, E2, E3, E4, E5, E6, E7 | fifth bimetallic signal transmitter |
| M1 | first layer of the bimetallic strip |
| M2 | second layer of the bimetallic strip |

1. Forest fire early detection system (1)
with a terminal,
wherein the terminal has a sensor unit (10),
characterized in that
the sensor unit (10) has a first bimetallic signal transmitter (A).

2. Forest fire early detection system (1) according to claim 1,
characterized in that
the sensor unit (10) has a second bimetallic signal transmitter (B),
wherein the first bimetallic signal transmitter (A) is different from the second bimetallic signal transmitter (B).

3. Forest fire early detection system (1) according to claim 1, characterized in that
the first (A) and/or the second bimetallic signal transmitter (B) is coupled to a piezo element (11, 12).

4. Forest fire early detection system (1) according to claim 1,
characterized in that
the switching temperature of the first bimetallic signal transmitter (A) is different from the switching temperature of the second bimetallic signal transmitter (B).

5. Forest fire early detection system (1) according to claim 1,
characterized in that
the sensor unit (10) has an array (100) of bimetallic signal transmitters (A, B, C, D, E1).

6. Forest fire early detection system (1) according to claim 5,
characterized in that
the array (100) has a plurality of different bimetallic signal transmitters (A, B, C, D, E1).

7. Forest fire early detection system (1) according to claim 6,
characterized in that
the plurality of different bimetallic signal transmitters (A, B, C, D, E1) of the sensor unit (10) have different signal temperatures,
wherein the respective bimetallic signal transmitter (A, B, C, D, E1) generates a signal when the signal temperature is reached.

8. Forest fire early detection system (1) according to claim 1,
characterized in that
the sensor unit (10) is coupled to a time detection.

9. Forest fire early detection system (1) according to claim 8,
characterized in that
the signal of the bimetallic signal transmitter (A, B, C, D, E1) detected by the sensor unit (10) can be stored coupled with the respective time of detection of the signal.

10. Forest fire early detection system (1) according to claim 1,
characterized in that
the forest fire early detection system (1) has a mesh gateway network with a first gateway and a second gateway,
wherein the first gateway communicates directly with other gateways and terminals of the mesh gateway network only, and the second gateway communicates with the network server.

11. Forest fire early detection system (1) according to claim 10,
characterized in that
the mesh gateway network comprises an LPWAN and preferably a LoRaWAN.

12. Forest fire early detection system (1) according to claim 10,
characterized in that
the terminals and/or the first gateways have a self-sufficient energy supply.

13. Forest fire early detection system (1) according to claim 10,
characterized in that
the terminals and/or the first gateways can be operated off-grid.

14. Method for detecting forest fires with the method steps:
Recording the amount of heat energy from a first bimetallic signal transmitter (A) of a forest fire early detection system (1),
Converting the amount of thermal energy into a deformation of the bimetallic strip (21) of the first bimetallic signal transmitter (A),
Generating a first signal by deforming the bimetallic strip (21) of the first bimetallic signal transmitter (A).

15. Method for detecting forest fires according to claim 14,
characterized in that
a second bimetallic signal transmitter (B) of the forest fire early detection system (1) absorbs an amount of heat energy, converts the amount of heat energy into a deformation of the bimetallic strip (22) of the second bimetallic signal transmitter (B) and a second signal is generated by the deformation of the bimetallic strip (22) of the second bimetallic signal generator (B).

16. Method for detecting forest fires according to claim 14, characterized in that
the first bimetallic signal transmitter (A) is different from the second bimetallic signal transmitter (B).

17. Method for detecting forest fires according to claim 16,
characterized in that
the first bimetallic signal transmitter (A) generates a signal at a signal temperature that is different from the signal temperature of the second bimetallic signal transmitter (B).

18. Method for detecting forest fires according to claim 14,
characterized in that
the signal generated by the first bimetallic signal transmitter (A) triggers a message from the terminal containing the first bimetallic signal transmitter (A) to a network server.

19. Method for detecting forest fires according to claim 14,
characterized in that
the time of generation of a signal generated by one of the bimetallic signal transmitters (A, B, C, D, E1) is detected.

20. Method for detecting forest fires according to claim 19,
characterized in that
the time between two signals detected by two different bimetallic signal transmitters (A, B, C, D, E1) is detected.

21. Method for detecting forest fires according to claim 20,
characterized in that
the detected time triggers a message from the terminal containing the bimetallic signal transmitter (A, B, C, D, E1) to a network server.

22. Method for detecting forest fires according to claim 21,
characterized in that
the detected time triggers a message from the terminal containing the bimetallic signal transmitter (A, B, C, D, E1) to a network server.

23. Method for detecting forest fires according to claim 14,
characterized in that
the method is carried out using a forest fire early detection system (1),
wherein the forest fire early detection (1) comprises a gateway network with a network server and multiple terminals,
wherein the sensor unit (10) is part of a terminal and the signals and/or the evaluated signals are transmitted via the gateway to the network server.

24. Method for detecting forest fires according to claim 23,
characterized in that
the forest fire early detection (1) has a mesh gateway network with a first gateway and a second gateway,
wherein the evaluated signals are transmitted via the first gateway and the second gateway to the network server.

25. Method for detecting forest fires according to claim 23,
characterized in that
the communication of the mesh gateway network takes place via an LPWAN and preferably a LoRaWAN protocol.

26. Method for detecting forest fires according to claim 14,
characterized in that
the terminal and/or the first gateways are supplied with energy via a self-sufficient energy supply.

27. Method for detecting forest fires according to claim 14,
characterized in that
the terminals and the first gateways are operated off-grid.
